(19) United States
(12) Patent Application Publication
(10) Pub. No.: US 2005/0271256 A1
(43) Pub. Date: Dec. 8, 2005

(54) Security system and a method of operating same

(76) Inventor: Hau Leung Stephen Chung, Hong Kong (CN)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/515,330

(22) PCT Filed: Feb. 2, 2004
(86) PCT No.: PCT/CN04/00092

§ 371 Date: Nov. 23, 2004

(51) Int. Cl. G06K 9/00

(52) U.S. Cl. 382/116

(57) ABSTRACT

A security system is disclosed as including input devices allowing input of access codes into the system; a door operatively associated with the input devices, the closure member being lockable to prevent access through an entrance; and the system is set to perform a first set of function(s) upon receipt of a first pre-defined access code to perform a second set of function(s) upon receipt of a second pre-defined access code; and both the first and second sets of function(s) include at least unlocking the closure member, thus allowing access through the entrance; and the first and second sets of function(s) differ at least in part from each other. A method of operating a security system with input devices allowing input of access codes into said system, and a door operatively associated with the input devices, the closure member being lockable to prevent access through an entrance, is disclosed as including the steps of (a) performing a first set of function(s) upon receipt of a first pre-defined access code; and (b) performing a second set of function(s) upon receipt of a second pre-defined access code; and both the first and second sets of function(s) include at least unlocking the door, thus allowing access through the entrance; and the first and second sets of function(s) differ at least in part from each other.

This invention relates to a security system, and in particular to a security system which perform different functions in response to input of different valid access codes. This invention also relates to a method of operating such a security system.

Traditional security systems typically secure a premise or a number of security “zones”. Any command given to the security system must be properly authorized, typically via a passcode or security key card. This is especially true when the security system is armed and a person tries to gain access to a secured area or disarm the system; in these cases, the person typically presents the security system with the passcode, or his fingerprint, or his keycard, or even his eye (for iris scan in high-security systems), possibly in combination depending on the particular setup of the security system.

Such conventional security systems typically accept a number of pre-set codes with universal access (i.e. everybody uses the same codes, e.g. passcodes), and a number of stored, personalized codes (e.g. keycards, fingerprints). However, all these codes are used to authenticate a person's attempt to access a secured area, and the types of actions that the security system performs after receiving these codes are pre-defined and uniform.

According to a first aspect of the present invention, there is provided a security system including at least one input device allowing input of access codes into said system; a closure member operatively associated with said at least one input device, said closure member being adapted to be locked to prevent access through an entrance; wherein said system is adapted to perform a first set of function(s) upon receipt of a first of a plurality of pre-defined access codes; wherein said system is adapted to perform a second set of function(s) upon receipt of a second of said plurality of pre-defined access codes; wherein both said first and second sets of function(s) include at least unlocking said closure member, thus allowing access through said entrance; and wherein said first and second sets of function(s) differ at least in part from each other.

According to a second aspect of the present invention, there is provided a method of operating a security system with at least one input device allowing input of access codes into said system, and a closure member operatively associated with said at least one input device, said closure member being adapted to be locked to prevent access through an entrance, including the steps of (a) performing a first set of function(s) upon receipt of a first of a plurality of pre-defined access codes; and (b) performing a second set of function(s) upon receipt of a second of said plurality of pre-defined access codes; wherein both said first and second sets of function(s) include at least unlocking said closure member, thus allowing access through said entrance; and wherein said first and second sets of function(s) differ at least in part from each other.

Briefly stated, the present invention differs from the conventional security systems in that a security system according to the present invention can perform different actions or functions based upon the particular access codes presented for gaining access, instead of simply resorting to a “grant/no-grant” type of security access.

In a security system according to the present invention, access codes are not simply used for authentication, although authentication can be one of the actions that is performed. Access codes that are presented to the system are also used as a cue for the system to perform actions or functions based on each particular code. This change in concept represents a fundamental shift in the operations flow of a security system, and enables implementation of a wide variety of unique features not found in existing commercial security systems. When coupled with an intelligent, integrated platform installed at the premise, as fully described in Hong Kong Short-Term Patent No. HK1052830, the content of which is fully incorporated herein as if fully repeated here, this feature allows immense flexibility in the actions and functions that the security system may perform.

To illustrate this new concept, we assume that a security system is installed to secure a vault with a locked door, and that the following valid passcodes are installed into the system: “1234” and “9876”. Both these codes will unlock the door of the vault. In addition, we also assume that the finger prints and key cards of a number of authorized personnel are stored in the system.

When an authorized person presents to the system the password “1234”, or scans his finger on a fingerprint reader, or places his keycard on a card reader associated with the security system, the security system will attempt to authenticate the person for access. If the password, or the fingerprint, or the keycard, or a combination of these three as defined by the system setup is valid, then the system will respond by unlocking the door of the vault, thus allowing access to the vault. Otherwise, the system may simply refuse to unlock the vault door, or may even contact the guard house, call the police or sound an alarm. However, this scenario does not prevent any of the following mishaps:
1. the passcodes have leaked, and an unauthorized person attempts to gain access;
2. an authorized person is held at gun-point to place his finger on the fingerprint reader; or
3. an authorized person has lost his keycard, and an unauthorized person attempts to gain access with the stolen card.

Because of this, some security systems resort to combinations of more than one access methods to counter these threats, e.g. requiring fingerprint scans plus keycard and passcode. Nevertheless, such a system is still unable to cope with the situation in which the authorized person is held at gun-point to gain access to the system.

In a security system according to the present invention, each valid access code is paired with a list of actions or functions that the system is to perform upon receipt of each respective valid access code. For example:
1. When the system receives, via a keypad, the passcode “1234”, it will unlock the vault door, whereas if the system receives, via the keypad, the passcode “9876”, it will unlock the vault door and at the same time inform the police by calling the police station.
2. When a user presents his/her right index finger to a finger print scanner, the system will unlock the vault door, whereas if the user presents his/her right middle finger to the finger print scanner, the system will unlock the vault door and at the same time inform the police by calling the police station.
3. When a user scans a keycard for less than 4 seconds, the system will unlock the vault door, whereas if he/she scans the keycard for more than 4 seconds, the system will unlock the vault door and at the same time inform the police by calling the police station.

Thus, in the context of the present invention, an “access code” can also mean the manner in which an passcode is presented to or inputted into an input device.

When this type of system is in use, when the authorized person presents a valid access code to the security system, the system will take different actions depending on the particular code presented. For example, during normal access, the person may key in “1234” via a keypad, or scan his/her right index finger to unlock the vault door. On the other hand, he may key in “9876” via the keypad, or scan his/her right middle finger to unlock the vault door when he is being forced to do so, all the while knowing that the police will be informed as well. The unauthorized threat holding that person hostage has no idea that the system is functioning differently. That is because the system no longer only authenticates, it performs different sets of actions and functions based on the access codes presented to it.

This is but one example out of many that a system according to the present invention may represent a breakthrough in security features.

An actual implementation of multi-layered access methods can be found in the intelligent home platform. Within that platform is a security module that contains, among others, a central database storing all valid access codes, distinguished by type. Furthermore, each valid access code is mapped to a series of actions and functions that the security system will perform, or will ask the intelligent home platform to perform. For example:

| No. | Type | Access code | Location | Action(s) |
|---|---|---|---|---|
| 01 | Passcode | 1234 | Front door keypad | Open door lock, disarm |
| | | | | security, and put on John's |
| | | | | favorite music |
| 02 | Passcode | 5555 | Front door keypad | Open door lock, disarm |
| | | | | security, and put on Jane's |
| | | | | favorite music |
| 03 | Passcode | 9876 | Front door keypad | Open door lock, call police, |
| | | | | and turn on CCTV recorder |
| 04 | Passcode | 1234 | Front gate keypad | Open front gate, and disarm |
| | | | | perimeter |
| 05 | Passcode | 5555 | Front gate keypad | Open front gate, and disarm |
| | | | | perimeter |
| 06 | Passcode | 9876 | Front gate keypad | Open front gate, call police, |
| | | | | and turn on CCTV recorder |
| 07 | Fingerprint | <John's right | Front door fingerprint | Open door lock, disarm |
| | | index finger> | scanner | security, and put on John's |
| | | | | favorite music |
| 08 | Fingerprint | <John's right | Front door fingerprint | Open door lock, call police, |
| | | middle finger> | scanner | and turn on CCTV recorder |
| 09 | Fingerprint | <Jane's right | Front door fingerprint | Open door lock, disarm |
| | | index finger> | scanner | security, and put on Jane's |
| | | | | favorite music |
| 10 | Fingerprint | <Jane's right | Front door fingerprint | Open door lock, call police, |
| | | middle finger> | scanner | and turn on CCTV recorder |
| 11 | Passcode | 1234 | Security panel | Disarm system, and say “Hello |
| | | | | John, system disarmed” |
| 12 | Passcode | 5555 | Security panel | Disarm system, and say “Hello |
| | | | | Jane, system disarmed” |
| 13 | Passcode | 9876 | Security panel | Fake disarm system, call |
| | | | | police, set system to simulated |
| | | | | disarmed mode, and turn on all |
| | | | | video recorders and |
| | | | | microphones |

This example assumes that the system is provided with two keypads, one at the front door and one at the front gate to the garden, a security panel (for arming and disarming), and a finger print scanner at the front door.

If John tries to enter the house with his passcode “1234” at the front door keypad, or with his right index finger on the front door fingerprint scanner, the security system will attempt to locate the corresponding entry within the database. In this case, the matched entry will be entry No. 01 (for passcode) or No. 07 (for fingerprint). Then the system will perform the following actions in sequence:

Action 1: Open door lock

Action 2: Disarm security system

Action 3: Play John's favorite music

Similarly for Jane, her favorite music will be played if she enters with her passcode “5555” or her right index finger.

Assuming, however, that John is being held at gun-point to enter his house. He places his right middle finger on the finger print scanner at the front door. The security system, again, will attempt to locate the corresponding entry, which in this case is entry No. 08. The system will then perform the following actions in sequence:

Action 1: Open door lock

Action 2: Call police

Action 3: Turn on closed circuit television (CCTV) recorder

Notice that the security system is not disarmed, and that the police is notified. The intruder will only notice that the door is unlocked, as should be since John is an authorized person to enter the house. John, however, will know that the system has already informed the police and is recording the incident on CCTV since his favorite music is not played.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

1. A security system including:
at least one input device allowing input of access codes into said system;
a closure member operatively associated with said at least one input device, said closure member being adapted to be locked to prevent access through an entrance;
wherein said system is adapted to perform a first set of function(s) upon receipt of a first of a plurality of pre-defined access codes;
wherein said system is adapted to perform a second set of function(s) upon receipt of a second of said plurality of pre-defined access codes;
wherein both said first and second sets of function(s) include at least unlocking said closure member, thus allowing access through said entrance; and
wherein said first and second sets of function(s) differ at least in part from each other.

2. A security system according to claim 1 wherein said at least one input device includes a keypad, a security panel, a card reader, or a finger print reader.

3. A security system according to claim 1 wherein said second set of functions further include informing the police.

4. A security system according to claim 1 wherein said second set of functions further include turning on a closed circuit television recorder.

5. A method of operating a security system with at least one input device allowing input of access codes into said system, and a closure member operatively associated with said at least one input device, said closure member being adapted to be locked to prevent access through an entrance, including the steps of (a) performing a first set of function(s) upon receipt of a first of a plurality of pre-defined access codes; and (b) performing a second set of function(s) upon receipt of a second of said plurality of pre-defined access codes; wherein both said first and second sets of function(s) include at least unlocking said closure member, thus allowing access through said entrance; and wherein said first and second sets of function(s) differ at least in part from each other.

6. A method according to claim 5 wherein said at least one input device includes a keypad, a security panel, a card reader, or a finger print reader.

7. A method according: to claim 5 wherein said second set of functions further include informing the police.

8. A method according to claim 5 wherein said second set of functions further include turning on a closed circuit television recorder.
